(19) United States
(12) Patent Application Publication
(10) Pub. No.: US 2024/0230463 A1
(43) Pub. Date: Jul. 11, 2024

(54) METHOD AND SYSTEM FOR IMAGE EVALUATION OF NEAR-EYE DISPLAYS

(71) Applicant: JADE BIRD DISPLAY (SHANGHAI) LIMITED, SHANGHAI (CN)

(72) Inventor: Xingtong JIANG, Shanghai (CN)

(21) Appl. No.: 18/409,718

(22) Filed: Jan. 10, 2024

(30) Foreign Application Priority Data
Jan. 11, 2023 (WO) PCT/CN2023/071794

(51) Int. Cl. G01M 11/02; G01N 21/88

(52) U.S. Cl. CPC G01M 11/0278; G01M 11/0207; G01N 21/8851

(57) ABSTRACT

A method for image evaluation of a near-eye display (NED) includes: dividing a full view field of the NED into a plurality of sub-view-fields; obtaining a plurality of sub-images corresponding to the plurality of sub-view-fields; synthesizing the plurality of sub-images to obtain a full image; and evaluating the full image to determine if it contains at least one visual artefact or nonuniformity distribution.

### CROSS-REFERENCE TO RELATED APPLICATIONS

The present disclosure claims priority to and the benefits of PCT Application No. PCT/CN2023/071794, filed on Jan. 11, 2023, which is incorporated herein by reference in its entirety.

### TECHNICAL FIELD

The present disclosure generally relates to near-eye display technology, and more particularly, to a method and a system for image evaluation of near-eye displays.

### BACKGROUND

Near-eye displays (NEDs) may be provided as an augmented reality (AR) display, a virtual reality (VR) display, a Head Up/Head Mount, or other displays. Generally, a NED usually comprises an image generator and an optical combiner. The image generator is commonly a projector with micro displays (e.g., micro-LED (light-emitting diode), micro-OLED (organic light-emitting diode), LCOS (liquid crystal on silicon), or DLP (digital light processing)) and optical lens integrated. The optical combiner includes reflective and/or diffractive optics, such as freeform mirror/prism, birdbath, cascaded mirrors, or grating coupler (waveguide). A virtual image is rendered from NEDs to human eyes with/without ambient light.

The field of view (FOV) of VR devices is generally in a range of 80-150 degrees, and the FOV of AR devices is generally in a range of 30-70 degrees. The maximum angular resolution of the human eye is generally 60 dots (pixels) per degree. Since NEDs are viewed very close to the eye, they are displays with the highest resolution, which contain the most pixels in a smallest form factor in order to obtain a seamless viewing experience.

A measuring system for measuring and evaluating performance parameters of a NED should have sufficient resolution to capture pixel-wise details which may be visible to the human eyes in the NEDs. However, it is difficult for the measuring system to balance both an imaging FOV and an imaging resolution. When a wide measuring FOV is selected, the resolution of the measuring system is relatively low, resulting in the loss of pixel-level details in the image, thereby decreasing an overall performance. If a high-resolution image is required, the measuring FOV becomes smaller, which may not meet the requirements for the full FOV.

### SUMMARY OF THE DISCLOSURE

Embodiments of the present disclosure provide a method for image evaluation of a near-eye display (NED), the method includes: dividing a full view field of the NED into a plurality of sub-view-fields; obtaining a plurality of sub-images corresponding to the plurality of sub-view-fields; synthesizing the plurality of sub-images to obtain a full image; and evaluating the full image to determine if it contains at least one visual artefact or nonuniformity distribution.

Embodiments of the present disclosure provide a system for image evaluation of a near-eye display (NED), the system includes: a light measuring device (LMD) configured to: obtain a plurality of sub-images corresponding to a plurality of sub-view-fields displayed by the NED; and evaluate the full image to determine if it contains at least one visual artefact or nonuniformity distribution; and a processor configured to: synthesize the plurality of sub-images to obtain the full image; wherein a full view field of device under test (DUT) is divided into the plurality of sub-view-fields.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 is a schematic diagram of an exemplary system for image evaluation of an NED, according to some embodiments of the present disclosure.

FIG. 2 illustrates a flowchart of an exemplary method for image evaluation of an NED, according to some embodiments of the present disclosure.

FIG. 3 illustrates an example of sub-view-fields with smaller FOV for measuring, according to some embodiments of the present disclosure.

FIG. 4 illustrates a flowchart of another exemplary method for image evaluation of an NED, according to some embodiments of the present disclosure.

FIG. 5 illustrates an example of sub-test patterns in a method for image evaluation of an NED, according to some embodiments of the present disclosure.

FIG. 6 illustrates a flowchart of an exemplary method for image evaluation of an NED, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms and/or definitions incorporated by reference.

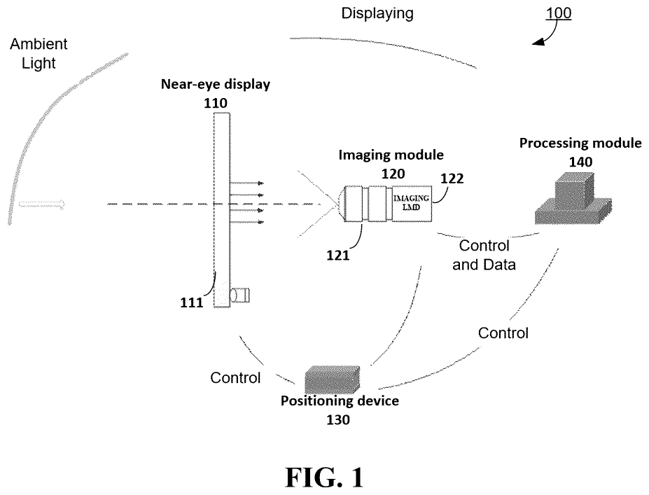

FIG. 1 is a schematic diagram of an exemplary system 100 for image evaluation of an NED, according to some embodiments of the present disclosure. As shown in FIG. 1, system 100 includes a near-eye display (NED) 110 for displaying images to human eyes, an imager provided as an imaging module 120, a positioner provided as a positioning device 130, and a processor provided as a processing module 140. Additionally, ambient light can be provided by an ambient light module (not shown). NED 110 can be provided as an AR (augmented reality) display, a VR (virtual reality) display, a Head-Up/Head-Mount display, a projector or other displays. Positioning device 130 is provided to set an appropriate spatial relation between NED 110 and imaging module 120. For example, positioning device 130 is configured to set a distance between NED 110 and imaging module 120 in a general range of 10 mm-25 mm. Positioning device 130 can further adjust the relative positions (e.g., the distance and spatial position) of NED 110 and imaging module 120. Imaging module 120 is configured to emulate the human eye to measure display optical characteristics and to observe display performance. In some embodiments, imaging module 120 can include an array light measuring device (LMD) 122 and a lens 121. For example, LMD 122 can be a colorimeter or an imaging camera, such as a CCD (charge coupled device) or a CMOS (complementary metal oxide semiconductor) image sensor. The lens 121 can be NED lens or normal lens, according to an absolute or relative value measure. NED lens of imaging module 120 is provided with a front aperture having a small diameter of, e.g., 1 mm-6 mm. Lens 121 can provide a wide FOV in front, and lens 121 is configured to emulate a human eye to observe NED 110. The optical properties of a virtual image displayed by NED 110 are measured by imaging module 120 based on positioning device 130.

In some embodiments, NED 110 can include an image generator 111, and an optical combiner, also referred to herein as image optics (not shown in FIG. 1). Image generator 111 can be a micro display such as a micro-LED, micro-OLED, LCOS, or DLP display, and can be configured as a light engine with an additional projector lens. In some embodiments, the micro display includes a micro display panel and a plurality of lens. The micro display panel includes a micro light emitting array which can form an active emitting area. For example, the micro display panel can be a micro inorganic-LED display panel, a micro-OLED display panel, or a micro-LCD display panel. The projected image from the light engine through designed optics is transferred to human eyes through the optical combiner. The optics of the optical combiner can be reflective and/or diffractive optics, such as a free form mirror/prism, birdbath, or cascaded mirrors, grating coupler (waveguide), etc.

Processing module 140 is configured to evaluate and improve the uniformity of the virtual image rendered by NED 110. In some embodiments, processing module 140 can be included in a computer or a server. In some embodiments, processing module 140 can be deployed in the cloud, which is not limited herein. In some embodiments, processing module 140 can include one or more processors.

In some embodiments, a driver provided as a driving module (not shown in FIG. 1) can be further provided to drive the image for display by NED 110. The drive module can be coupled to communicate with NED 110, specifically to communicate with image generator 111 of NED 110. For example, the driving module can be configured to adjust the gray values of image generator 111.

A view field of a virtual image rendered by NED 110 is normally larger than 30 degrees (diagonal), for example 60-120 degrees. To fit a wide NED device under test (DUT) FOV, the imaging module 120 is required to meet the corresponding view field. For example, lens 121 may have a much wider FOV for measuring, such as 120 degrees. Therefore, imaging module 120 may suffer a relative much low angular resolution, due to the wide measuring FOV. As a result, pixel-wise details are lost because of the low performance (e.g., low resolution) of imaging module 120. If a high resolution of LMD 122 is achieved by decreasing the FOV of LMD 122, the measuring FOV can be much smaller or sufficient for the DUT FOV in one shot imaging.

To measure a wider DUT FOV flexibly with a high resolution in pixel-wise details, a method for measuring an image is proposed according to some embodiments of the present disclosure. According to this method, a full view field for rendering a virtual image is divided into a plurality of sub-view-fields, and a plurality of sub-images are captured for each of the plurality of sub-view-fields with a smaller FOV and high resolution LMD, respectively. The plurality of sub-images are synthesized into one single image for the full view field.

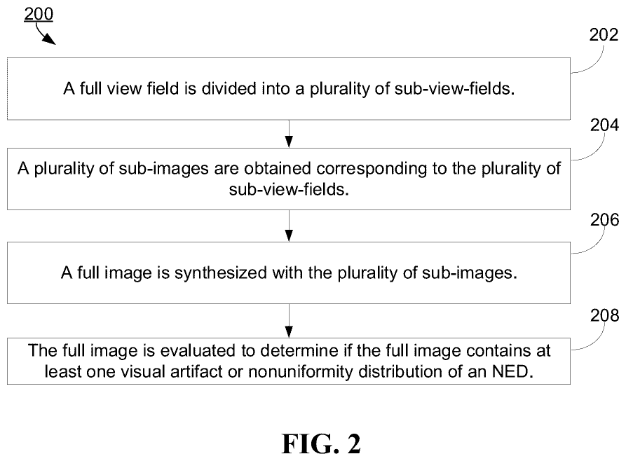

FIG. 2 illustrates a flowchart of an exemplary method 200 for image evaluation of an NED, according to some embodiments of the present disclosure. Method 200 includes steps 202 to 208.

At step 202, a full view field is divided into a plurality of sub-view-fields. Each sub-view-field has a smaller FOV than the full view field. A full test pattern is rendered to obtain a virtual image in the full view field, e.g., a DUT FOV. For example, for a full view field with an FOV of 120 degrees, the full view field can be divided into four sub-view-fields and each sub-view-field has an FOV of 30 degrees. For a full view field with an FOV of 60 degrees, the full view field can be divided into two sub-view-fields, and each sub-view-field has an FOV of 30 degrees. Each sub-view field corresponds to the measuring FOV. In some embodiments, the full view field can be divided the horizontal direction. In some embodiments, the full view field can be divided in the vertical direction. In some embodiments, the division in the horizontal and vertical directions can be combined.

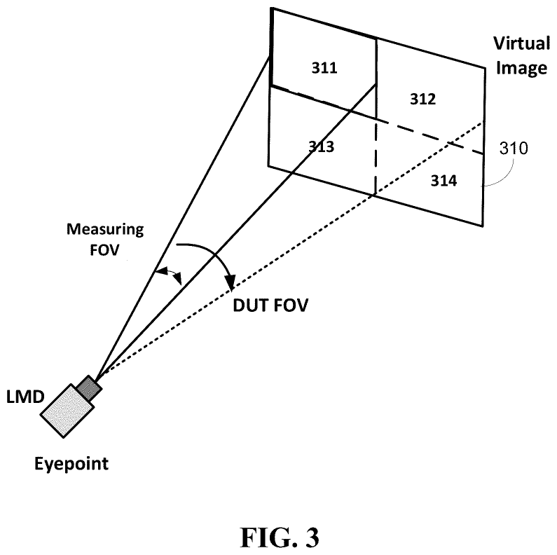

In some embodiments, the division of the full view field can be realized by dividing the virtual image, which is rendered in the full view field. FIG. 3 illustrates an example of sub-view-fields with smaller FOV for measuring, according to some embodiments of the present disclosure. As shown in FIG. 3, a full test pattern is rendered in a full view field 310 displayed as a virtual image. The full view field (e.g., DUT FOV) 310 is divided into four sub-view-fields (e.g., measuring FOVs) 311 to 314. In this example, the DUT FOV is divided in the horizontal direction and the vertical direction, respectively, to obtain a smaller measuring FOV for each sub-view-field. Therefore, a high resolution in pixel-wise details can be obtained by the LMD.

It can be understood that the degrees for FOV described herein are just for illustrative purpose, and do not constitute a limitation of the present disclosure. For example, the measuring FOV can be 15 degrees, 20 degrees, 40 degrees, 45 degrees, etc. The measuring FOV can be selected and determined based on the properties of the LMD, for example, the resolution of the LMD, etc.

In some embodiments, the plurality of sub-view-fields may overlap. For example, for a full view field with an FOV of 100 degrees, the full view field can be divided into four sub-view-fields, each of the four sub-view-field having an FOV of 30 degrees. Therefore, a partial view field can be overlapped.

At step 204, a plurality of sub-images are obtained corresponding to the plurality of sub-view-fields. Since each of the sub-view-fields has a smaller FOV, the sub-images can be obtained with high resolution in pixel-wise details. It can be understood that the LMD 122 can adaptively obtain a sub-image for each sub-view-field, as long as the sub-view-field is within the FOV of the LMD 122.

At step 206, a full image is synthesized with the plurality of sub-images. The full image for the full view field is obtained by combining all the sub-images. In some embodiments, the data of sub-images are synthesized to obtain full image data. Compared with obtaining a full image by capturing the full view field in one shot, the full image obtained by the plurality of sub-images has high resolution in pixel-wise details.

At step 208, the full image is evaluated to determine if the full image contains at least one visual artefact or nonuniformity distribution. For example, the visual artefact may include mura/pixel defects. The nonuniformity distribution is further used to demura or correct nonuniformity. In some embodiments, optical characteristics are obtained based on the full image, and the visual artefact is detected based on the optical characteristics. For example, the optical characteristics may include luminance and/or chromaticity.

With the above-described method, a full image with greater DUT FOV can be obtained by synthesizing a plurality of sub-images with high resolution under a smaller measuring FOV. Therefore, both great FOV and high resolution for NED measurement can be achieved.

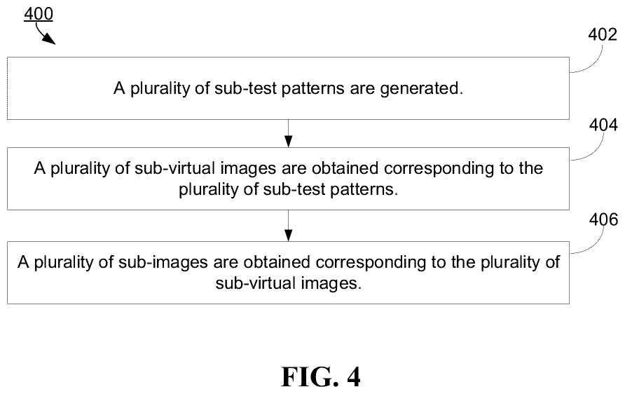

In some embodiments, step 204 may be implemented as obtaining the plurality of sub-images by rendering a plurality of sub-test patterns and capturing a plurality of sub-virtual images. FIG. 4 illustrates a flowchart of another exemplary method 400 for image evaluation of an NED, according to some embodiments of the present disclosure. As show in FIG. 4, the method 400 may further include steps 402 to 406.

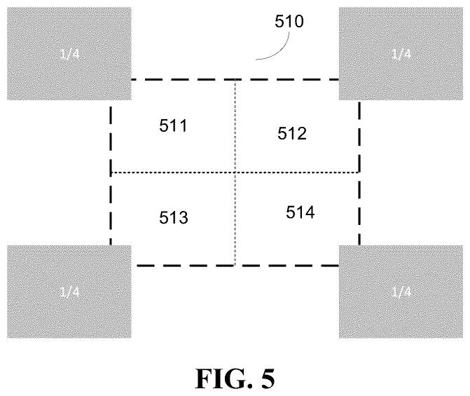

At step 402, a plurality of sub-test patterns are generated. Each sub-test pattern corresponds to a sub-view-field. The plurality of sub-test patterns can be combined to form a full test pattern. In some embodiments, the sub-test patterns can be overlapped. FIG. 5 illustrates an example of sub-test patterns in a method for image evaluation of an NED, according to some embodiments of the present disclosure. As shown in FIG. 5, a full image 510 (for example, 1920×1080 pixels) is divided into four sub-test pattern 511 to 514. Each of the four sub-test patterns has a resolution of 480×270 pixels. For example, a gray value of a sub-test pattern is set at 255 (8bits) (i.e., full solid white). The sub-test pattern can be driven in sequence to the NED system and render a corresponding virtual image with a corresponding view field based on the sample for DUT.

In some embodiments, the sub-test pattern can be a full solid white pattern with a specific gray value or a partial white pattern with partial on/off pixels. If the NED DUT is monochrome, the sub-test pattern is a single primary channel of R/G/B (red, green or blue). In some embodiments, the full test pattern may be divided unevenly, and the sub-test patterns can overlap between the adjacent sub-test patterns. In some embodiments, the sub-test pattern is further divided into several sub patterns with partial on-off pixels for achieving higher pixel-level clarity in the subsequent imaging procedures. In some embodiments, the sub-test pattern is not limited to a rectangle or a square, and can be a circle or any other shapes. The number of the sub-test patterns depends on the sample for DUT and the NED system, for example, the DUT FOV and/or the resolution of the NED system. In some embodiments, the number of the sub-test patterns is in a range of 1 to 100.

At step 404, a plurality of sub-virtual images are obtained corresponding to the plurality of sub-test patterns. Each sub-virtual image corresponds to one sub-test pattern, and each sub-virtual image may have a smaller FOV, for example, the FOV of the sub-virtual image may be not greater than 30 degrees. The plurality of sub-virtual images corresponds to the plurality of sub-test patterns. Referring to FIG. 5, for example, a first sub-virtual image can be obtained by rendering the sub-test pattern 511, a second sub-virtual image can be obtained by rendering the sub-test pattern 512, a third sub-virtual image can be obtained by rendering the sub-test pattern 513, and a fourth sub-virtual image can be obtained by rendering the sub-test pattern 514. Each of the first sub-virtual image, the second sub-virtual image, the third sub-virtual image, and the fourth sub-virtual image has an FOV less than the FOV of the full virtual image, for example, an FOV not greater than 30 degrees.

At step 406, a plurality of sub-images are obtained corresponding to the plurality of sub-virtual images. For example, the sub-images are captured by the LMD of the NED system.

Other steps in FIG. 4 are the same as those described above or will describe hereinafter with reference to FIG. 2, which will not be repeated herein.

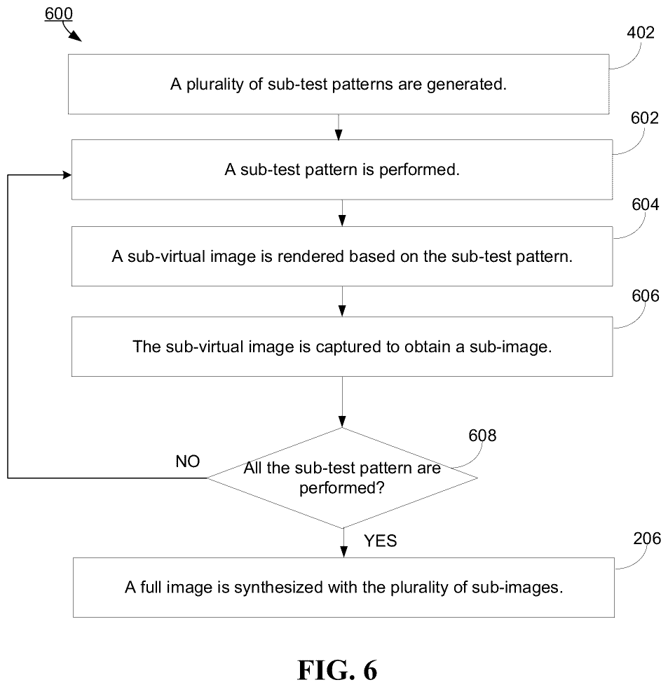

FIG. 6 illustrates a flowchart of an exemplary method 600 for image evaluation of an NED, according to some embodiments of the present disclosure. As shown in FIG. 6, steps 404 and 406 further include the following steps 602 to 608.

At step 602, a sub-test pattern is performed. For example, a sub-test pattern is performed for rendering a virtual image. In some embodiments, the sub-test pattern is performed by the image generator 111 of NED 110.

At step 604, a sub-virtual image is rendered based on the sub-test pattern. The sub-virtual image is displayed by NED 110 to LMD 122, and an FOV of the sub-virtual image is smaller than an FOV of a full virtual image, for example, the FOV of the sub-virtual image is not greater than 30 degrees.

At step 606, the sub-virtual image is captured to obtain a sub-image. In some embodiments, the sub-virtual image is captured by the LMD 122. In some embodiments, the obtained sub-image is a high-resolution image. A registration of the virtual image to a source image can be applied as well.

At step 608, it is determined whether all the sub-test patterns have been performed. Referring to the example shown in FIG. 5, a total number of sub-test patterns is 4. If there is still a sub-test pattern that has not been performed, a next sub-test pattern is then performed, that is, steps 602 to 608 are repeated until all the sub-test patterns are performed, and all the sub-virtual images are obtained. If all the sub-test patterns are performed, that is, in this example, the 4 sub-test patterns are all performed, performance of steps 404 and 406 are completed.

Other steps in FIG. 6 are the same as those described above or will describe hereinafter with reference to FIG. 2 and FIG. 4, which will not be repeated herein.

In some embodiments, the captured sub-virtual image is temporarily stored in the LMD 122 and transmitted to a processor as a batch after all the sub-virtual images are captured. In some embodiments, the captured sub-virtual image is transmitted to the processor once it is captured, and then stored in the processor for further processing.

In some embodiments of the present disclosure, a device for image evaluation of a NED is provided. The device can perform the above-described methods. Referring back to FIG. 1, the imaging module 120 is further configured to obtain a plurality of sub-images corresponding to a plurality of sub-view-fields; and evaluate the full image to determine if it contains at least one visual artefact or nonuniformity distribution. The processing module 140 is further configured to generate the plurality of sub-images; and synthesize the plurality of sub-images to obtain the full image. A full view field of device under test (DUT) is divided into the plurality of sub-view-fields.

In some embodiments, the processing module 140 is further configured to generate a plurality of sub-test patterns for a full test pattern; and obtain a plurality of sub-virtual images corresponding to the plurality of sub-test patterns. The plurality of sub-virtual images correspond to the plurality of sub-view-fields.

In some embodiments, the NED 110 is further configured to render a sub-virtual image based on a sub-test pattern. The imaging module 120 is configured to capture a corresponding sub-virtual image to obtain a sub-image. The driver module (not shown) is further configured to control the NED 110 and imaging module 120 to repeat the rendering and the capturing until all the plurality of sub-test patterns have been performed.

In some embodiments, the imaging module 120 is further configured to obtain optical characteristics of the full image; and detect a visual artefact based on the optical characteristics.

The details of each step performed by system 100 are the same as the methods described above with reference to FIG. 2 to FIG. 6, which will not repeated herein.

It should be noted that relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. A method for image evaluation of a near-eye display (NED), comprising:
dividing a full view field of the NED into a plurality of sub-view-fields;
obtaining a plurality of sub-images corresponding to the plurality of sub-view-fields;
synthesizing the plurality of sub-images to obtain a full image; and
evaluating the full image to determine if it contains at least one visual artefact or nonuniformity distribution.

2. The method according to claim 1, wherein dividing a full view field of the NED into a plurality of sub-view-fields further comprises:
generating a plurality of sub-test patterns for a full test pattern; and
obtaining, by the NED, a plurality of sub-virtual images corresponding to the plurality of sub-test patterns, wherein the plurality of sub-virtual images correspond to the plurality of sub-view-fields.

3. The method according to claim 2, wherein obtaining the plurality of sub-images corresponding to the plurality of sub-view-fields further comprises:
performing one of the generated sub-test patterns;
rendering, by the NED, a sub-virtual image for the sub-test patterns and capturing the sub-virtual image; and
repeating the rendering and the capturing until all the plurality of sub-test patterns have been performed.

4. The method according to claim 1, wherein the sub-image is obtained by a light measuring device (LMD).

5. The method according to claim 1, wherein evaluating the full image to determine if it contains at least one visual artefact further comprises:
obtaining an optical characteristic of the full image; and
detecting the visual artefact based on the optical characteristics.

6. The method according to claim 5, wherein the optical characteristic comprises luminance and/or chromaticity.

7. The method according to claim 1, wherein the plurality of sub-images are partially overlapped.

8. The method according to claim 1, wherein a shape of the sub-view-field is a rectangle, a square, or a circle.

9. A system for image evaluation of a near-eye display (NED), comprising:
a light measuring device (LMD) configured to:
obtain a plurality of sub-images corresponding to a plurality of sub-view-fields displayed by the NED; and
evaluate a full image to determine if it contains at least one visual artefact or nonuniformity distribution; and
a processor configured to:
synthesize the plurality of sub-images to obtain the full image;
wherein a full view field of the NED is divided into the plurality of sub-view-fields.

10. The system according to claim 9, wherein the processor is further configured to generate a plurality of sub-test patterns for a full test pattern; and obtain a plurality of sub-virtual images corresponding to the plurality of sub-test patterns, wherein the plurality of sub-virtual images correspond to the plurality of sub-view-fields.

11. The system according to claim 10, wherein the NED is further configured to render a sub-virtual image for a sub-test pattern; the LMD is configured to capture the sub-virtual image to obtain the sub-image; and the system further comprises a driver configured to control the NED and LMD to repeat the rendering and the capturing until all the plurality of sub-test patterns have been performed.

12. The system according to claim 9, wherein the LMD is further configured to:
obtain an optical characteristic of the full image; and
detect the visual artefact based on the optical characteristics.

13. The system according to claim 12, wherein the optical characteristic comprises luminance.

14. The system according to claim 12, wherein the optical characteristic comprises chromaticity.

15. The system according to claim 9, wherein the plurality of sub-images are partially overlapped.

16. The system according to claim 9, wherein a shape of the sub-view-field is a rectangle, a square, or a circle.
